(19) United States
(12) Patent Application Publication
(10) Pub. No.: US 2013/0300839 A1
(43) Pub. Date: Nov. 14, 2013

(54) PORTABLE ELECTRONIC DEVICE FOR CAPTURING 3D IMAGES AT ANY USAGE ANGLE

(71) Applicant: MIN-CHIEH CHAI, PENGHU COUNTY (TW)

(72) Inventor: MIN-CHIEH CHAI, PENGHU COUNTY (TW)

(73) Assignee: HANNSTAR DISPLAY CORPORATION, NEW TAIPEI CITY (TW)

(21) Appl. No.: 13/539,112

(22) Filed: Jun. 29, 2012

(30) Foreign Application Priority Data
May 11, 2012 (CN) 201210146328.5

(51) Int. Cl. H04N 13/02

(52) U.S. Cl. 348/47; 348/E13.074

(57) ABSTRACT

A portable electronic device includes a carrier unit and an image-capturing unit. The carrier unit includes a carrier body. The image-capturing unit includes a rotatable element rotatably disposed on the carrier body, two image-capturing modules embedded in the rotatable element, and a weight element disposed inside the rotatable element. The rotatable element has a first geometric center point concurrently passed by a first horizontal line and a vertical line, each image-capturing module has a second geometric center point itself passed by the first horizontal line, the weight element has a third geometric center point passed by a second horizontal line and the vertical line, and the first horizontal line and the second horizontal line are horizontal to each other. Therefore, because the two image-capturing modules are always held in a horizontal state, the portable electronic device can capture high quality 3D images at any usage angle.

### BACKGROUND OF THE INVENTION

1. Field of the Invention

The instant disclosure relates to a portable electronic device, and more particularly to a portable electronic device for capturing 3D images at any usage angle.

2. Description of Related Art

With the coming age of information technology and the advance of network technologies, mobile phones (or cell phones) become one of the most widespread communication tools. Cell phones become increasingly popular for consumers due to their attribution of small in sizes, portability, versatile in functions, and most importantly, the steadily decreasing price. In terms of purchasing cell phones, the appearances and functions are the determining factors for majority buyers. Hence, the market responds to this trend by providing multi-functional, new and good-looking cell phones.

A traditional smart phone provides two cameras mated with each other for capturing 3D images. However, when the smart phone is rotated to change its usage angle (such as an inclined angle), the usage angle of the two cameras is changed according to the change of the usage angle of the smart phone due to the two cameras fixed on the smart phone, thus the two cameras cannot be always held in a horizontal state. Therefore, when the usage angle of the smart phone is inclined, the traditional smart phone cannot use the two inclined cameras to capture high quality 3D images.

### SUMMARY OF THE INVENTION

One aspect of the instant disclosure relates to a portable electronic device for capturing 3D images at any usage angle.

One of the embodiments of the instant disclosure provides a portable electronic device for capturing 3D images at any usage angle, comprising: a carrier unit and an image-capturing unit. The carrier unit includes a carrier body. The image-capturing unit includes a rotatable element rotatably disposed on the carrier body, at least two image-capturing modules embedded in the rotatable element, and at least one weight element disposed inside the rotatable element, wherein the rotatable element has a first geometric center point that is concurrently passed by a first horizontal line and a vertical line, each image-capturing module has a second geometric center point itself that is passed by the first horizontal line, the weight element has a third geometric center point that is passed by a second horizontal line and the vertical line, and the first horizontal line and the second horizontal line are horizontal to and separated from each other.

More precisely, the carrier body has a front side and a back side, the carrier unit includes a display screen disposed on the front side of the carrier body, and the image-capturing unit is disposed on the back side of the carrier body.

More precisely, the vertical line is vertical to the first horizontal line and the second horizontal line, and the at least two image-capturing modules are symmetrically disposed on opposite sides of the vertical line.

More precisely, the carrier body has a receiving groove, and the rotatable element is rotatably disposed in the receiving groove of the carrier body, wherein the carrier body has a sliding groove communicated with the receiving groove, and the carrier unit includes a securing element slidably disposed in the sliding groove of the carrier body, wherein the securing element has a first retaining portion, the rotatable element has a second retaining portion corresponding to the first retaining portion, and the first retaining portion is positioned at one of a first position and a second position, wherein the first position is for securing the rotatable element by retaining the first retaining portion with the second retaining portion, and the second position is for releasing the rotatable element by separating the first retaining portion from the second retaining portion.

More precisely, the carrier body has a receiving groove, and the rotatable element is rotatably disposed in the receiving groove of the carrier body, wherein the carrier body has a sliding groove communicated with the receiving groove, and the carrier unit includes a securing element slidably disposed in the sliding groove of the carrier body, wherein the securing element has a first magnetic portion, the rotatable element has a second magnetic portion corresponding to the first magnetic portion, and the first magnetic portion is positioned at one of a first position and a second position, wherein the first position is for securing the rotatable element by magnetically mating the first magnetic portion with the second magnetic portion, and the second position is for releasing the rotatable element by separating the first magnetic portion from the second magnetic portion.

More precisely, the carrier body has a receiving groove, and the rotatable element is rotatably disposed in the receiving groove of the carrier body, wherein the carrier unit includes a securing element disposed in the receiving groove of the carrier body, and the rotatable element is liftably disposed in receiving groove, wherein the rotatable element is positioned at one of a first position and a second position, and the first position is for securing the rotatable element by tightly mating the rotatable element with the securing element, and the second position is for releasing the rotatable element by separating the rotatable element from the securing element.

More precisely, the carrier body has a receiving groove, and the rotatable element is rotatably disposed in the receiving groove of the carrier body, wherein the carrier body has a positioning groove communicated with the receiving groove, and the carrier unit includes a securing element corresponding to the positioning groove of the carrier body, wherein the securing element has an end portion is positioned at one of a first position and a second position, the first position is for securing the rotatable element by retaining the end portion of the securing element in the positioning groove, and the second position is for releasing the rotatable element by separating the end portion of the securing element from the positioning groove.

Another one of the embodiments of the instant disclosure provides a portable electronic device for capturing 3D images at any usage angle, comprising: a carrier unit and an image-capturing unit. The carrier unit includes a carrier body. The image-capturing unit includes a rotatable element rotatably disposed on the carrier body and at least two image-capturing modules embedded in the rotatable element, wherein the rotatable element has a first geometric center point that is concurrently passed by a first horizontal line and a vertical line, each image-capturing module has a second geometric center point itself that is passed by a second horizontal line, and the first horizontal line and the second horizontal line are horizontal to and separated from each other.

More precisely, the carrier body has a front side and a back side, the carrier unit includes a display screen disposed on the front side of the carrier body, and the image-capturing unit is disposed on the back side of the carrier body.

More precisely, the carrier body has a receiving groove, and the rotatable element is rotatably disposed in the receiving groove of the carrier body, wherein the carrier body has a sliding groove communicated with the receiving groove, and the carrier unit includes a securing element slidably disposed in the sliding groove of the carrier body, wherein the securing element has a first retaining portion, the rotatable element has a second retaining portion corresponding to the first retaining portion, and the first retaining portion is positioned at one of a first position and a second position, wherein the first position is for securing the rotatable element by retaining the first retaining portion with the second retaining portion, and the second position is for releasing the rotatable element by separating the first retaining portion from the second retaining portion.

More precisely, the carrier body has a receiving groove, and the rotatable element is rotatably disposed in the receiving groove of the carrier body, wherein the carrier body has a sliding groove communicated with the receiving groove, and the carrier unit includes a securing element slidably disposed in the sliding groove of the carrier body, wherein the securing element has a first magnetic portion, the rotatable element has a second magnetic portion corresponding to the first magnetic portion, and the first magnetic portion is positioned at one of a first position and a second position, wherein the first position is for securing the rotatable element by magnetically mating the first magnetic portion with the second magnetic portion, and the second position is for releasing the rotatable element by separating the first magnetic portion from the second magnetic portion.

More precisely, the carrier body has a receiving groove, and the rotatable element is rotatably disposed in the receiving groove of the carrier body, wherein the carrier unit includes a securing element disposed in the receiving groove of the carrier body, and the rotatable element is liftably disposed in receiving groove, wherein the rotatable element is positioned at one of a first position and a second position, and the first position is for securing the rotatable element by tightly mating the rotatable element with the securing element, and the second position is for releasing the rotatable element by separating the rotatable element from the securing element.

More precisely, the carrier body has a receiving groove, and the rotatable element is rotatably disposed in the receiving groove of the carrier body, wherein the carrier body has a positioning groove communicated with the receiving groove, and the carrier unit includes a securing element corresponding to the positioning groove of the carrier body, wherein the securing element has an end portion is positioned at one of a first position and a second position, the first position is for securing the rotatable element by retaining the end portion of the securing element in the positioning groove, and the second position is for releasing the rotatable element by separating the end portion of the securing element from the positioning groove.

Yet another one of the embodiments of the instant disclosure provides a portable electronic device for capturing 3D images at any usage angle, comprising: a carrier unit, an image-capturing unit and a horizontal control unit. The carrier unit includes a carrier body. The image-capturing unit includes a rotatable element rotatably disposed on the carrier body and at least two image-capturing modules embedded in the rotatable element, wherein the rotatable element has a first geometric center point that is concurrently passed by a first horizontal line and a vertical line, and each image-capturing module has a second geometric center point itself that is passed by the first horizontal line. The horizontal control unit includes at least one gyroscope module electrically connected to the image-capturing unit for keeping the first horizontal line to pass through the second geometric center point itself of each image-capturing module, wherein the at least one gyroscope module is disposed inside one of the carrier body and the rotatable element.

More precisely, the carrier body has a front side and a back side, the carrier unit includes a display screen disposed on the front side of the carrier body, and the image-capturing unit is disposed on the back side of the carrier body.

More precisely, the vertical line is vertical to the first horizontal line, and the at least two image-capturing modules are symmetrically disposed on opposite sides of the vertical line.

More precisely, the e carrier body has a receiving groove, and the rotatable element is rotatably disposed in the receiving groove of the carrier body, wherein the carrier body has a sliding groove communicated with the receiving groove, and the carrier unit includes a securing element slidably disposed in the sliding groove of the carrier body, wherein the securing element has a first retaining portion, the rotatable element has a second retaining portion corresponding to the first retaining portion, and the first retaining portion is positioned at one of a first position and a second position, wherein the first position is for securing the rotatable element by retaining the first retaining portion with the second retaining portion, and the second position is for releasing the rotatable element by separating the first retaining portion from the second retaining portion.

More precisely, the carrier body has a receiving groove, and the rotatable element is rotatably disposed in the receiving groove of the carrier body, wherein the carrier body has a sliding groove communicated with the receiving groove, and the carrier unit includes a securing element slidably disposed in the sliding groove of the carrier body, wherein the securing element has a first magnetic portion, the rotatable element has a second magnetic portion corresponding to the first magnetic portion, and the first magnetic portion is positioned at one of a first position and a second position, wherein the first position is for securing the rotatable element by magnetically mating the first magnetic portion with the second magnetic portion, and the second position is for releasing the rotatable element by separating the first magnetic portion from the second magnetic portion.

More precisely, the carrier body has a receiving groove, and the rotatable element is rotatably disposed in the receiving groove of the carrier body, wherein the carrier unit includes a securing element disposed in the receiving groove of the carrier body, and the rotatable element is liftably disposed in receiving groove, wherein the rotatable element is positioned at one of a first position and a second position, and the first position is for securing the rotatable element by tightly mating the rotatable element with the securing element, and the second position is for releasing the rotatable element by separating the rotatable element from the securing element.

More precisely, the carrier body has a receiving groove, and the rotatable element is rotatably disposed in the receiving groove of the carrier body, wherein the carrier body has a positioning groove communicated with the receiving groove, and the carrier unit includes a securing element corresponding to the positioning groove of the carrier body, wherein the securing element has an end portion is positioned at one of a first position and a second position, the first position is for securing the rotatable element by retaining the end portion of the securing element in the positioning groove, and the second position is for releasing the rotatable element by separating the end portion of the securing element from the positioning groove.

Therefore, because the two image-capturing modules can be always held in a horizontal state, the portable electronic device can be used to capture high quality 3D images at any usage angle.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1A shows a front, schematic view of the portable electronic device according to the first embodiment of the instant disclosure;

FIG. 1B shows a back, schematic view of the portable electronic device used at a vertical angle according to the first embodiment of the instant disclosure;

FIG. 1C shows a perspective, schematic view of the portable electronic device disposed on another electronic device according to the first embodiment of the instant disclosure;

FIG. 1D shows a back, schematic view of the portable electronic device used at a horizontal angle according to the first embodiment of the instant disclosure;

FIG. 1E shows a back, schematic view of the portable electronic device used at an inclined angle according to the first embodiment of the instant disclosure;

FIG. 2A shows a back, schematic view of the portable electronic device having a rotatable element being secured according to the second embodiment of the instant disclosure;

FIG. 2B shows a back, schematic view of the portable electronic device having a rotatable element being released according to the second embodiment of the instant disclosure;

FIG. 3A shows a back, schematic view of the portable electronic device having a rotatable element being secured according to the third embodiment of the instant disclosure;

FIG. 3B shows a back, schematic view of the portable electronic device having a rotatable element being released according to the third embodiment of the instant disclosure;

FIG. 4A shows a back, schematic view of the portable electronic device according to the fourth embodiment of the instant disclosure;

FIG. 4B shows a cross-sectional, schematic view of the portable electronic device having a rotatable element being secured according to the fourth embodiment of the instant disclosure;

FIG. 4C shows a cross-sectional, schematic view of the portable electronic device having a rotatable element being released according to the fourth embodiment of the instant disclosure;

FIG. 5A shows a back, schematic view of the portable electronic device according to the fifth embodiment of the instant disclosure;

FIG. 5B shows a cross-sectional, schematic view of the portable electronic device having a rotatable element being secured according to the fifth embodiment of the instant disclosure;

FIG. 5C shows a cross-sectional, schematic view of the portable electronic device having a rotatable element being released according to the fifth embodiment of the instant disclosure;

FIG. 6A shows a back, schematic view of the portable electronic device used at a vertical angle according to the sixth embodiment of the instant disclosure;

FIG. 6B shows a back, schematic view of the portable electronic device used at a horizontal angle according to the sixth embodiment of the instant disclosure;

FIG. 6C shows a back, schematic view of the portable electronic device used at an inclined angle according to the sixth embodiment of the instant disclosure;

FIG. 7A shows a back, schematic view of the portable electronic device having a gyroscope module disposed in the carrier body according to the seventh embodiment of the instant disclosure; and

FIG. 7B shows a back, schematic view of the portable electronic device having a gyroscope module disposed in the rotatable element according to the seventh embodiment of the instant disclosure.

### DETAILED DESCRIPTION OF THE PREFERRED EMBODIMENTS

### First Embodiment

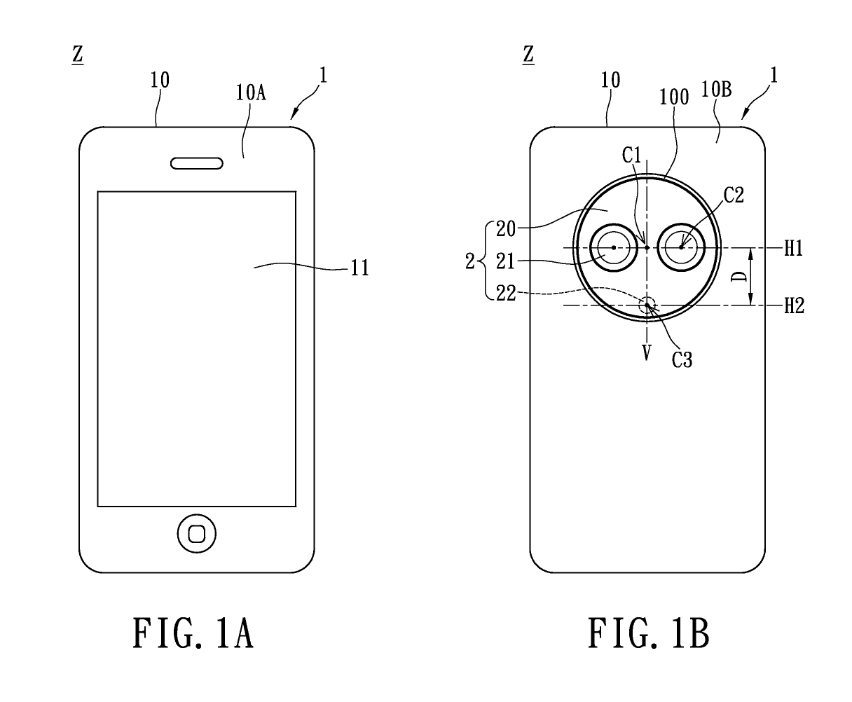

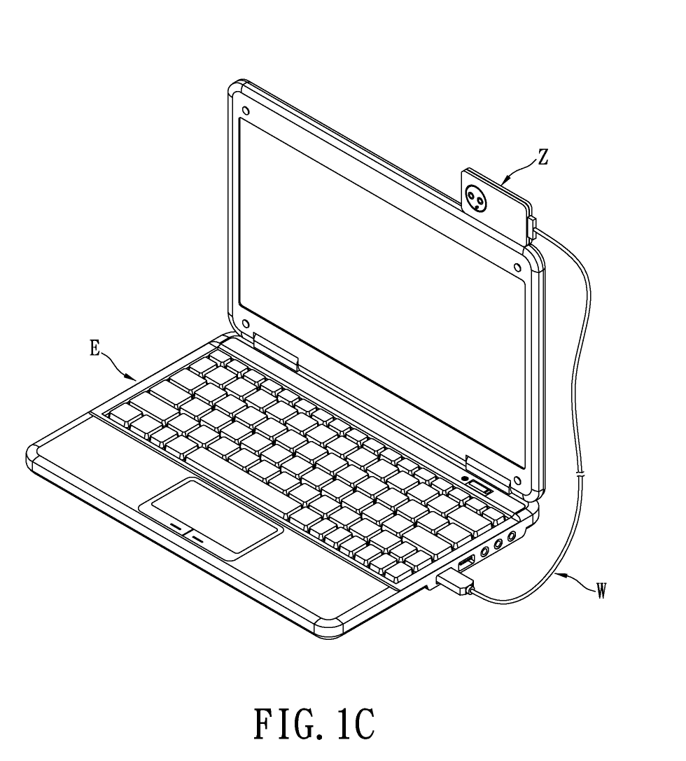

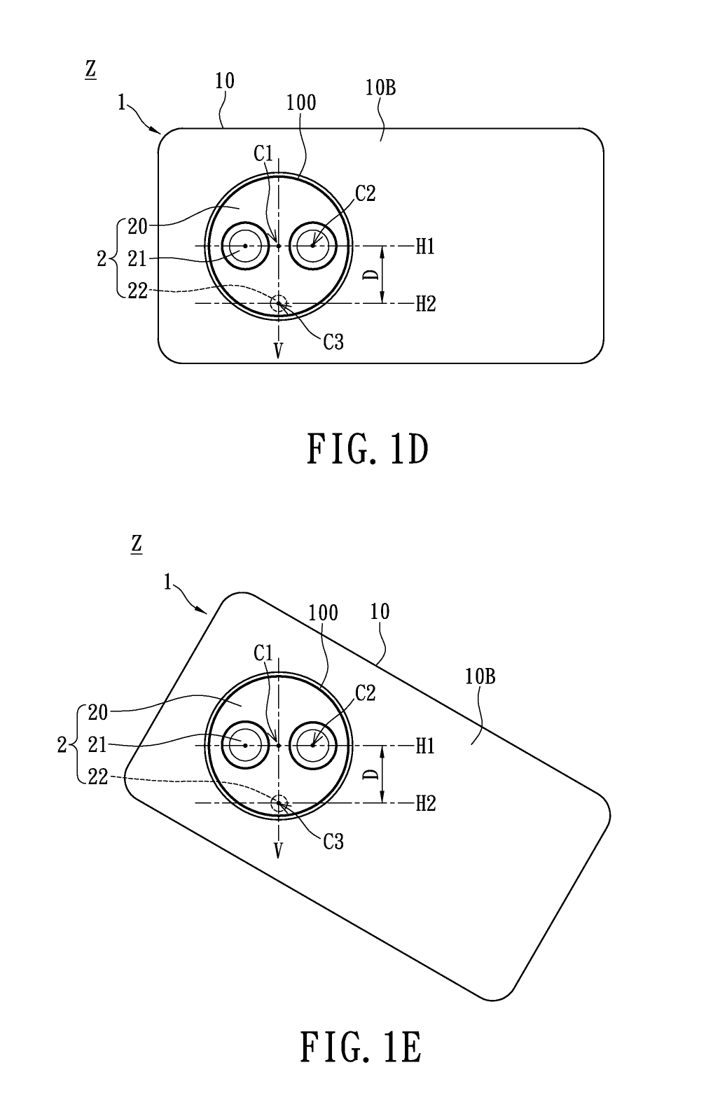

Referring to FIG. 1A to FIG. 1E, where the first embodiment of the instant disclosure provides a portable electronic device Z for capturing 3D images at any usage angle, comprising: a carrier unit 1 and an image-capturing unit 2.

Referring to FIG. 1A and FIG. 1B, the carrier unit 1 includes a carrier body 10, and the carrier body 10 has a receiving groove 100. For example, the carrier body 10 has a front side 10A and a back side 10B, and the image-capturing unit 2 can be disposed on the back side 10B of the carrier body 10. In another embodiment, the image-capturing unit 2 can be disposed on the front side 10A of the carrier body 10, or two image-capturing units 2 can be disposed on the front side 10A and the back side 10B of the carrier body 10, respectively. Moreover, if the portable electronic device Z is a mobile phone, the carrier body 10 is a phone body and the carrier unit 1 includes a display screen 11 disposed on the front side 10A of the carrier body 10. Hence, the user can preview the 3D image shown on the display screen 11 before capturing the 3D image. However, the portable electronic device Z used in the first embodiment is merely an example and is not meant to limit the instant disclosure. More precisely, the portable electronic device Z may be an extra module without using the display screen 11 as shown in FIG. 1C, or the portable electronic device Z may be an extra module having the display screen 11 as shown in FIG. 1A and FIG. 1B, according to different requirement. When the portable electronic device Z is placed on another electronic device E (such as a notebook computer or a mobile phone), the electronic device E can be electrically connected to the portable electronic device Z through a transmission line W (such as a USB transmission line), thus the electronic device E can be used to capture 3D image through the portable electronic device Z.

Moreover, referring to FIG. 1B, the image-capturing unit 2 includes a rotatable element 20 rotatably disposed on the carrier body 10, at least two image-capturing modules 21 embedded in the rotatable element 20, and at least one weight element 22 disposed inside the rotatable element 20, where the rotatable element 20 can be rotated relative to the carrier body 10, and the rotatable element 20 can be rotatably disposed in the receiving groove 100 of the carrier body 10. For example, the rotatable element 20 can be rotatably disposed on the carrier body 10 through a rotatable structure (such as ball bearing or any type of bearing), and the two image-capturing modules 21 can be continuously electrically connected to the carrier body 10 through a conductive piece. More precisely, the rotatable element 20 has a first geometric center point C1 (for example, when the rotatable element 20 is a right circular disk, the first geometric center point C1 of the rotatable element 20 equals to the gravity center point of the rotatable element 20) that is concurrently passed by a first horizontal line H1 and a vertical line V, each image-capturing module 21 has a second geometric center point C2 (for example, when each image-capturing module 21 is a right round body, the second geometric center point C2 of each image-capturing module 21 equals to the gravity center point of each image-capturing module 21) itself that is passed by the first horizontal line H1, the weight element 22 has a third geometric center point C3 (for example, when the weight element 22 is a right round body, the third geometric center point C3 of the weight element 22 equals to the gravity center point of the weight element 22) that is passed by a second horizontal line H2 and the vertical line V, and the first horizontal line H1 and the second horizontal line H2 are horizontal to each other and separated from each other by a predetermined distance D. In addition, the vertical line V is vertical to the first horizontal line H1 and the second horizontal line H2, and the at least two image-capturing modules 21 can be symmetrically disposed on opposite sides of the vertical line V. For example, the rotatable element 20 may be a round turntable or any turntable having a symmetrical shape. Referring to FIG. 1B, in this embodiment, there are two image-capturing modules 21 embedded in the rotatable element 20, each image-capturing module 21, for example, can comprise a camera module having an image-capturing lens (not shown) embedded in the rotatable element 20 and a light-transmitting element (not shown) exposed from the rotatable element 20 to protect the image-capturing lens. The weight element 22 can be made of metal or nonmetal material, and the weight element 22 may be an eccentric weight embedded in the rotatable element 20 by an extra subsequent process or integrally embedded in the rotatable element 20 by an injection molding process.

Furthermore, the two image-capturing modules 21 are symmetrically disposed on opposite sides of the vertical line V, and the first horizontal line H1 concurrently passes through the two second geometric center points C2 itself of the two image-capturing modules 21 and the first geometric center point C1 of the rotatable element 20. Thus, when the weight element 22 is embedded in the rotatable element 20 and the third geometric center point C3 of the weight element 22 is passed by the vertical line V and separated from the first geometric center point C1 of the rotatable element 20, the third geometric center point C3 of the weight element 22 can be acted as an eccentric point relative to the first geometric center point C1 of the rotatable element 20. More precisely, no matter the usage angle of the portable electronic device Z is changed by rotating, the second horizontal line H2 passing through the third geometric center point C3 of the weight element 22 is always horizontal to a level line of the Earth and the vertical line V passing through the third geometric center point C3 of the weight element 22 is always vertical to the level line by gravity, thus the first horizontal line H1 concurrently passing through the first geometric center point C1 of the rotatable element 20 and the two second geometric center points C2 itself of the two image-capturing modules 21 is always horizontal to the level line and the vertical line V passing through the first geometric center point C1 of the rotatable element 20 is always vertical to the level line by gravity. In other words, no matter how the usage angle of the portable electronic device Z is changed by a user, the weight element 22 can keep the first horizontal line H1 horizontal, thus the user can use the portable electronic device Z to capture high quality 3D images at any usage angle.

For example, referring to FIG. 1B, FIG. 1D and FIG. 1E, no matter the portable electronic device Z is rotated to a vertical usage angle (as shown in FIG. 1B), a horizontal usage angle (as shown in FIG. 1D) or an inclined usage angle (as shown in FIG. 1E), the weight element 22 can keep the first horizontal line H1 horizontal due to the eccentric third geometric center point C3 disposed relative to the first geometric center point C1, thus the two image-capturing modules 21 can be always symmetrically and horizontally disposed on opposite sides of the vertical line V. Therefore, no matter how the usage angle of the portable electronic device Z is changed, the usage angle of the two image-capturing modules 21 cannot be changed, thus the user can use the portable electronic device Z to capture high quality 3D images at any usage angle.

### Second Embodiment

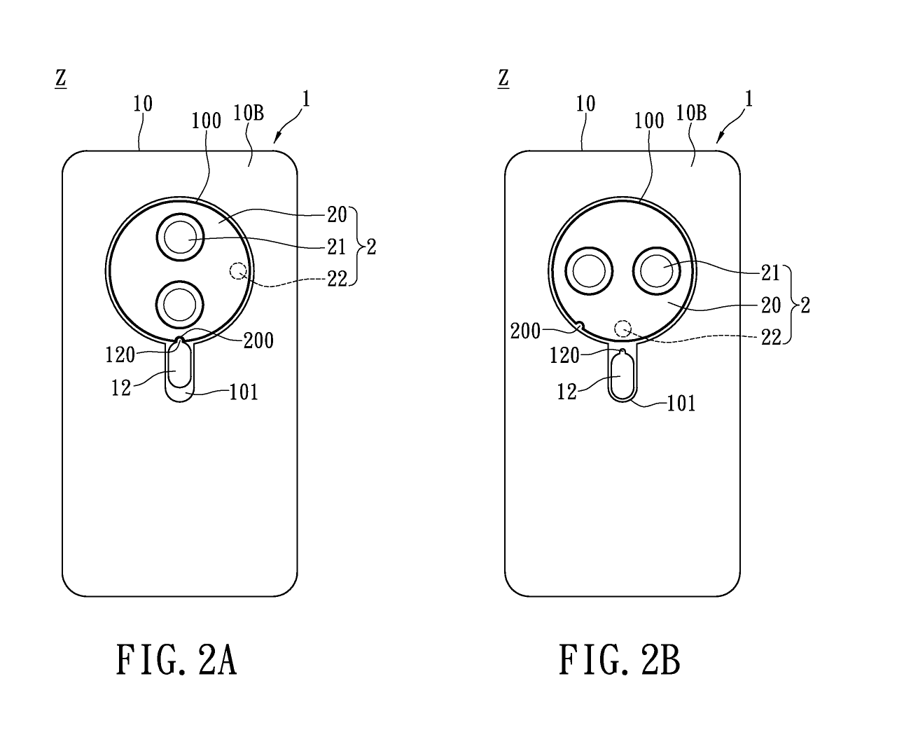

Referring to FIG. 2A and FIG. 2B, where the second embodiment of the instant disclosure provides a portable electronic device Z for capturing 3D images at any usage angle, comprising: a carrier unit 1 and an image-capturing unit 2. The difference between the second embodiment and the first embodiment is as follows: in the second embodiment, the carrier body 10 has a sliding groove 101 communicated with the receiving groove 100, and the carrier unit 1 includes a securing element 12 slidably disposed in the sliding groove 101 of the carrier body 10. In addition, the securing element 12 has a first retaining portion 120 (such as a protrusion portion) disposed on an end side thereof, and the rotatable element 20 has a second retaining portion 200 (such as a concave portion) disposed on a peripheral surface thereof and corresponding to the first retaining portion 120.

For example, when the first retaining portion 120 is positioned at a first position for securing the rotatable element 20 by retaining the first retaining portion 120 with the second retaining portion 200 (as shown in FIG. 2A), the usage angle of the two image-capturing modules 21 can be changed according to the change of the usage angle of the portable electronic device Z due to the rotatable element 20 secured by the securing element 12. In addition, when the first retaining portion 120 is positioned at a second position for releasing the rotatable element 20 by separating the first retaining portion 120 from the second retaining portion 200 (as shown in FIG. 2B), no matter how the usage angle of the portable electronic device Z is changed by a user, the weight element 22 can keep the two image-capturing modules 21 horizontal due to the rotatable element 20 released by the securing element 12, thus the user can use the portable electronic device Z to capture high quality 3D images at any usage angle. In other words, the first retaining portion 120 can be selectively positioned at the first position (as shown in FIG. 2A) for securing the rotatable element 20 by retaining the first retaining portion 120 with the second retaining portion 200 or the second position (as shown in FIG. 2B) for releasing the rotatable element 20 by separating the first retaining portion 120 from the second retaining portion 200.

### Third Embodiment

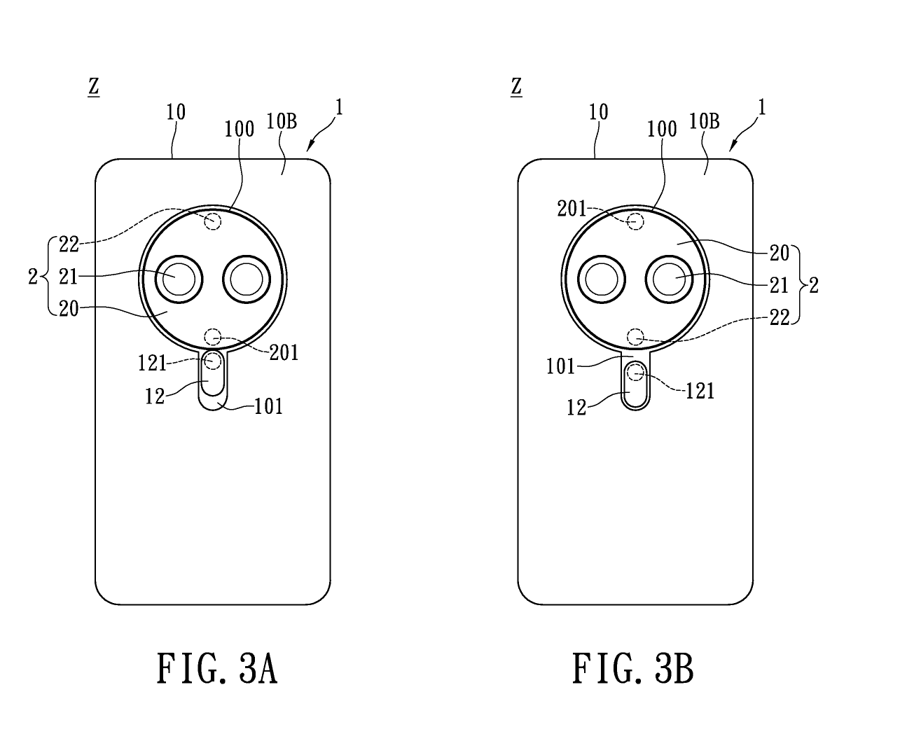

Referring to FIG. 3A and FIG. 3B, where the third embodiment of the instant disclosure provides a portable electronic device Z for capturing 3D images at any usage angle, comprising: a carrier unit 1 and an image-capturing unit 2. The difference between the third embodiment and the first embodiment is as follows: in the third embodiment, the carrier body 10 has a sliding groove 101 communicated with the receiving groove 100, and the carrier unit 1 includes a securing element 12 slidably disposed in the sliding groove 101 of the carrier body 10. In addition, the securing element 12 has a first magnetic portion 121 disposed on an end thereof, and the rotatable element 20 has a second magnetic portion 201 disposed therein and corresponding to the first magnetic portion 121. It's worth mentioning that the weight of the second magnetic portion 201 is very smaller than that of the weight element 22, thus the rotatable element 20 still can be rotated by the eccentric gravity generated by the weight element 22 diverged from the first horizontal line H1. Besides, the position of the second magnetic portion 201 is not limited as FIG. 3 shown, in other embodiment, the second magnetic portion 201 can be positioned anywhere in the rotatable element 20 or can be even integrally integrated with the weight element 22.

For example, when the first magnetic portion 121 is positioned at a first position for securing the rotatable element 20 by magnetically mating the first magnetic portion 121 with the second magnetic portion 201 (as shown in FIG. 3A), the usage angle of the two image-capturing modules 21 can be changed according to the change of the usage angle of the portable electronic device Z due to the rotatable element 20 secured by the securing element 12. In addition, when the first magnetic portion 121 is positioned at a second position for releasing the rotatable element 20 by separating the first magnetic portion 121 from the second magnetic portion 201 (as shown in FIG. 3B), no matter how the usage angle of the portable electronic device Z is changed by a user, the weight element 22 can keep the two image-capturing modules 21 horizontal due to the rotatable element 20 released by the securing element 12, thus the user can use the portable electronic device Z to capture high quality 3D images at any usage angle. In other words, the first magnetic portion 121 can be selectively positioned at the first position (as shown in FIG. 3A) for securing the rotatable element 20 by magnetically mating the first magnetic portion 121 with the second magnetic portion 201 or the second position (as shown in FIG. 3B) for releasing the rotatable element 20 by separating the first magnetic portion 121 from the second magnetic portion 201.

### Fourth Embodiment

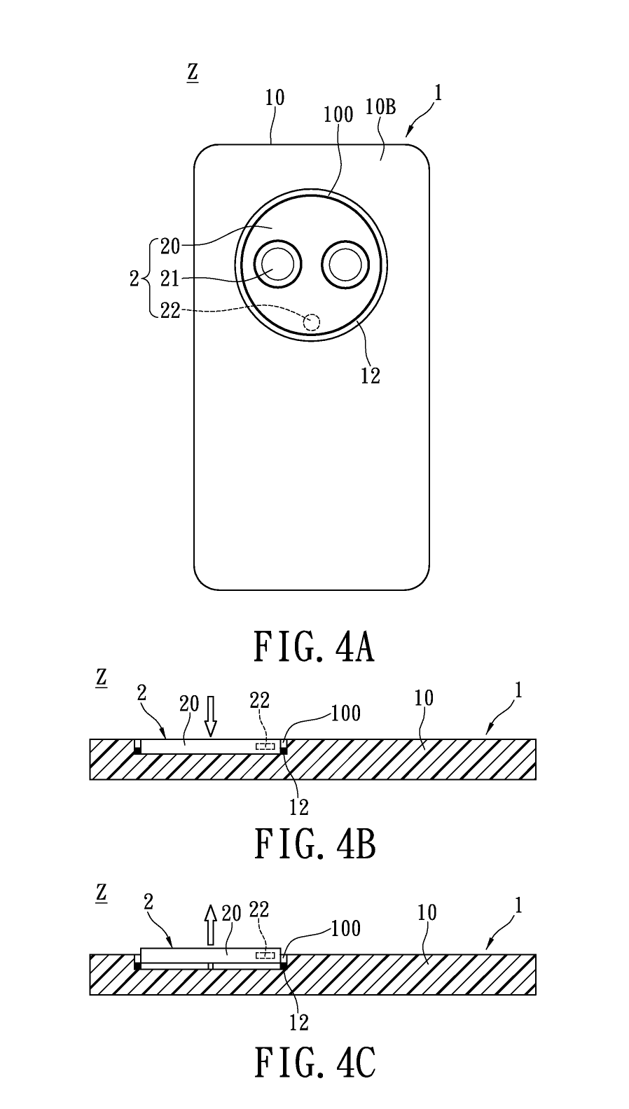

Referring to FIG. 4A to FIG. 4C, where the fourth embodiment of the instant disclosure provides a portable electronic device Z for capturing 3D images at any usage angle, comprising: a carrier unit 1 and an image-capturing unit 2. The difference between the fourth embodiment and the first embodiment is as follows: in the fourth embodiment, the carrier unit 1 includes a securing element 12 (such as a securing ring) disposed in the receiving groove 100 of the carrier body 10, and the rotatable element 20 is liftably disposed in receiving groove 100. In addition, the securing element 12 can be made of rubber material or any other material that can be tightly mated with the edge of the rotatable element 20 by friction. It's worth mentioning that the rotatable element 20 can be selectively moved upwardly or downwardly by many rising and setting method such as pressing or pulling.

For example, when the rotatable element 20 is positioned at a first position is for securing the rotatable element 20 by tightly mating the rotatable element 20 with the securing element 12 (as shown in FIG. 4B), the usage angle of the two image-capturing modules 21 can be changed according to the change of the usage angle of the portable electronic device Z due to the rotatable element 20 secured by the securing element 12. In addition, when the rotatable element 20 is positioned at a second position for releasing the rotatable element 20 by separating the rotatable element 20 from the securing element 12 (as shown in FIG. 4C), no matter how the usage angle of the portable electronic device Z is changed by a user, the weight element 22 can keep the two image-capturing modules 21 horizontal due to the rotatable element 20 released by the securing element 12, thus the user can use the portable electronic device Z to capture high quality 3D images at any usage angle. In other words, the rotatable element 20 can be selectively positioned at the first position (as shown in FIG. 4B) for securing the rotatable element 20 by tightly mating the rotatable element 20 with the securing element 12 or the second position (as shown in FIG. 4C) for releasing the rotatable element 20 by separating the rotatable element 20 from the securing element 12.

### Fifth Embodiment

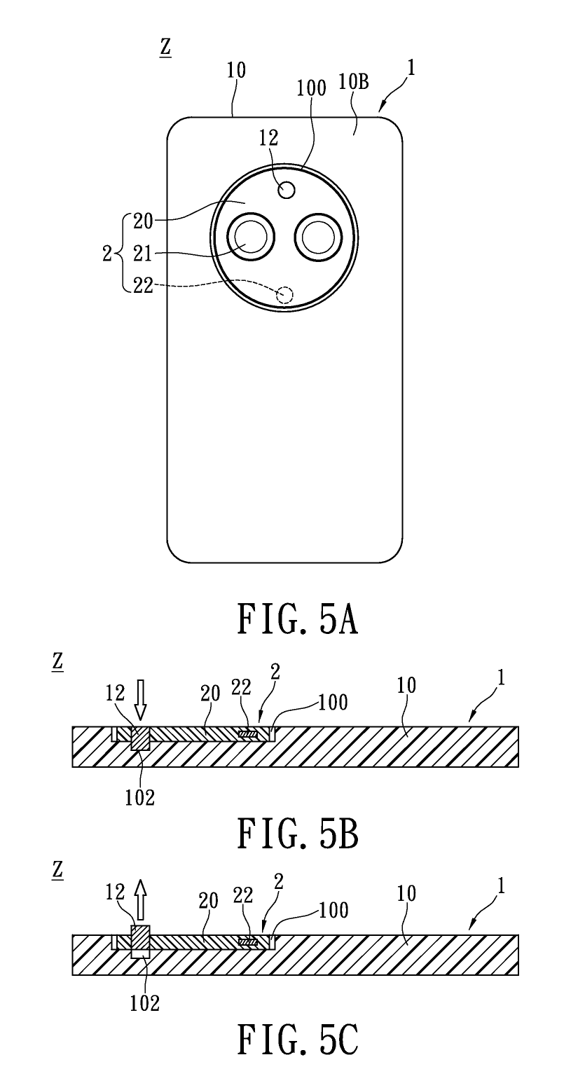

Referring to FIG. 5A to FIG. 5C, where the fifth embodiment of the instant disclosure provides a portable electronic device Z for capturing 3D images at any usage angle, comprising: a carrier unit 1 and an image-capturing unit 2. The difference between the fifth embodiment and the first embodiment is as follows: in the fifth embodiment, the carrier body 10 has a positioning groove 102 communicated with the receiving groove 100, and the carrier unit 1 includes a securing element 12 corresponding to the positioning groove 102 of the carrier body 10.

For example, when the end portion of the securing element 12 is positioned at a first position for securing the rotatable element 20 by retaining the end portion of the securing element 12 in the positioning groove 102 (as shown in FIG. 5B), the usage angle of the two image-capturing modules 21 can be changed according to the change of the usage angle of the portable electronic device Z due to the rotatable element 20 secured by the securing element 12. In addition, when the end portion of the securing element 12 is positioned at a second position for releasing the rotatable element 20 by separating the end portion of the securing element 12 from the positioning groove 102 (as shown in FIG. 5C), no matter how the usage angle of the portable electronic device Z is changed by a user, the weight element 22 can keep the two image-capturing modules 21 horizontal due to the rotatable element 20 released by the securing element 12, thus the user can use the portable electronic device Z to capture high quality 3D images at any usage angle. In other words, the end portion of the securing element 12 can be selectively positioned at the first position (as shown in FIG. 5B) for securing the rotatable element 20 by retaining the end portion of the securing element 12 in the positioning groove 102 or the second position (as shown in FIG. 5C) for releasing the rotatable element 20 by separating the end portion of the securing element 12 from the positioning groove 102. It's worth mentioning that the weight of the securing element 12 is very smaller than that of the weight element 22, thus the rotatable element 20 still can be rotated by the eccentric gravity generated by the weight element 22 diverged from the first horizontal line H1. Besides, the position of the securing element 12 is not limited as FIG. 5 shown, in other embodiment, the second magnetic portion 201 can be positioned anywhere in the rotatable element 20 or can be even integrally integrated with the weight element 22.

### Sixth Embodiment

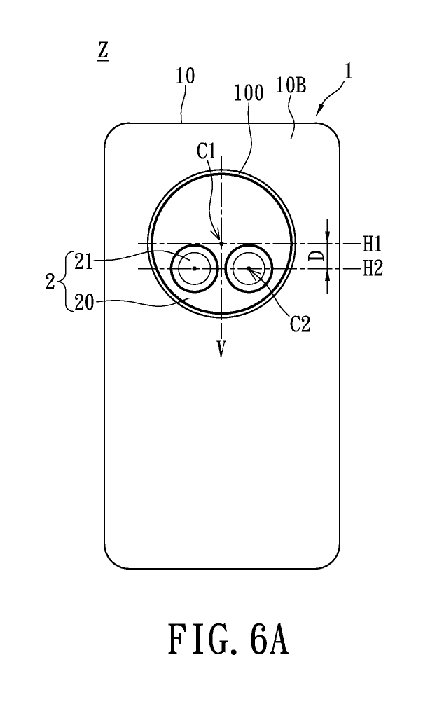

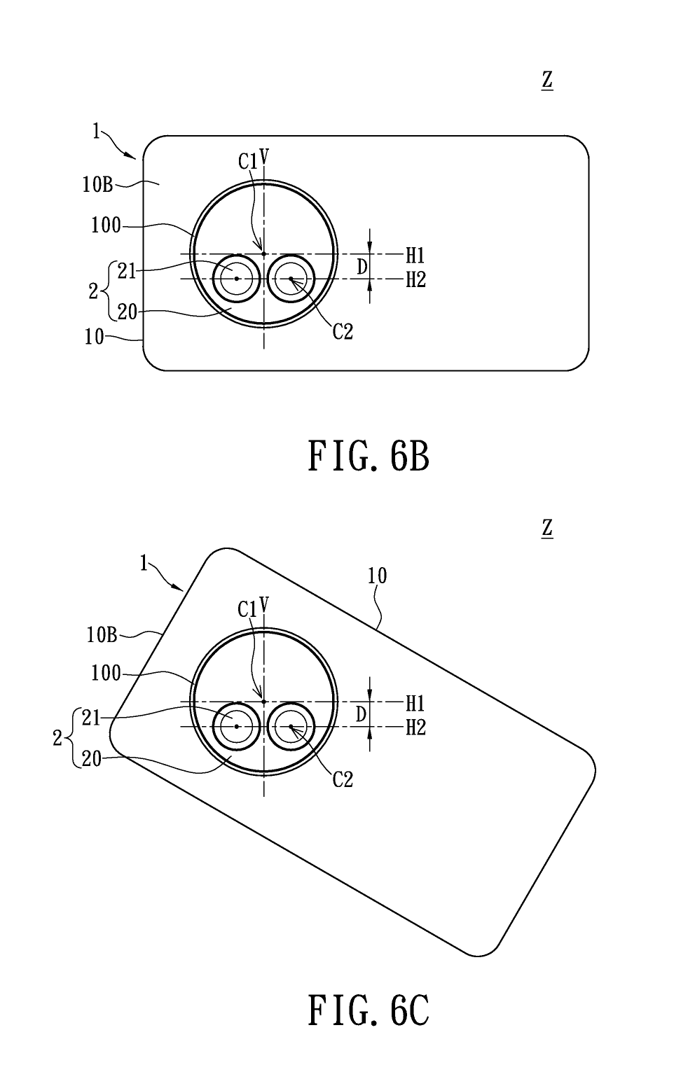

Referring to FIG. 6A to FIG. 6C, where the sixth embodiment of the instant disclosure provides a portable electronic device Z for capturing 3D images at any usage angle, comprising: a carrier unit 1 and an image-capturing unit 2. Comparing FIG. 6A with FIG. 1B, the difference between the sixth embodiment and the first embodiment is as follows: in the sixth embodiment, the image-capturing unit 2 includes a rotatable element 20 rotatably disposed on the carrier body 10 and at least two image-capturing modules 21 embedded in the rotatable element 20. In addition, the rotatable element 20 has a first geometric center point C1 that is concurrently passed by a first horizontal line H1 and a vertical line V, each image-capturing module 21 has a second geometric center point C2 itself that is passed by a second horizontal line H2, and the first horizontal line H1 and the second horizontal line H2 are horizontal to each other and separated from each other by a predetermined distance D. More precisely, the rotatable element 20 can be rotated by the eccentric gravity generated by the two image-capturing modules 21 diverged from the first horizontal line H1. That is, in the embodiment, the two image-capturing modules 21 are acted as the character of the weight element.

Hence, no matter the portable electronic device Z is rotated to a vertical usage angle (as shown in FIG. 6A), a horizontal usage angle (as shown in FIG. 6B) or an inclined usage angle (as shown in FIG. 6C), the two image-capturing modules 21 can keep the second horizontal line H2 horizontal due to the two eccentric and symmetric second geometric center point C2 itself disposed relative to the first geometric center point C1, thus the two image-capturing modules 21 can be always symmetrically and horizontally disposed on opposite sides of the vertical line V. Therefore, no matter how the usage angle of the portable electronic device Z is changed, the usage angle of the two image-capturing modules 21 cannot be changed, thus the user can use the portable electronic device Z to capture high quality 3D images at any usage angle. Of course, the portable electronic device Z of the sixth embodiment can use the securing element 12 as shown in the first embodiment to the fifth embodiments to selectively secure or release the rotatable element 20.

### Seventh Embodiment

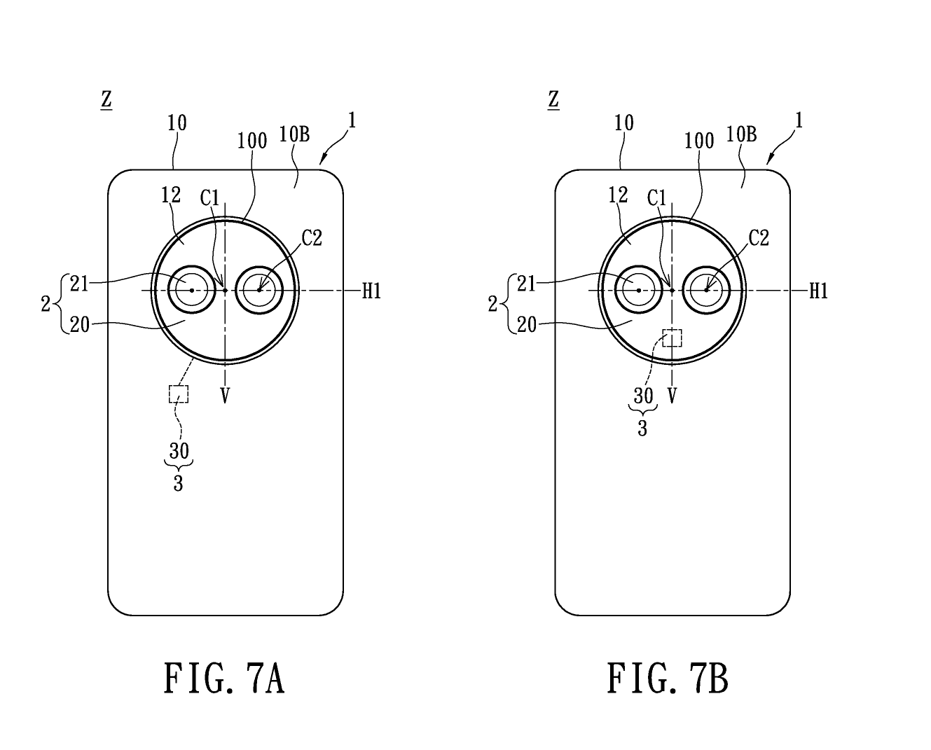

Referring to FIG. 7A and FIG. 7B, where the seventh embodiment of the instant disclosure provides a portable electronic device Z for capturing 3D images at any usage angle, comprising: a carrier unit 1, an image-capturing unit 2 and a horizontal control unit 3. Comparing FIG. 7A (or FIG. 7B) with FIG. 1B, the difference between the seventh embodiment and the first embodiment is as follows: the eccentric function provided by the weight element 22 of the first embodiment can be replaced by the eccentric function provided by the horizontal control unit 3 of the seventh embodiment. Furthermore, the image-capturing unit 2 includes a rotatable element 20 rotatably disposed on the carrier body 10 and at least two image-capturing modules 21 embedded in the rotatable element 20, where the rotatable element 20 has a first geometric center point C1 that is concurrently passed by a first horizontal line H1 and a vertical line V, and each image-capturing module 21 has a second geometric center point C2 itself that is passed by the first horizontal line H1. In addition, the horizontal control unit 3 includes at least one gyroscope module 30 electrically connected to the image-capturing unit 2 for keeping the first horizontal line H1 to pass through the second geometric center point C2 itself of each image-capturing module 21, and the gyroscope module 30 can be disposed inside the carrier body 10 (as shown in FIG. 7A) or the rotatable element 20 (as shown in FIG. 7B). In other words, the gyroscope module 30 is selectively disposed inside one of the carrier body 10 (as shown in FIG. 7A) and the rotatable element 20 (as shown in FIG. 7B) according to different requirements. For example, the rotatable element 20 can be connected to a rotary motor (not shown). When the portable electronic device Z is rotated to an inclined usage angle, the gyroscope module 30 can sense the inclined usage angle and drive the rotary motor to reversely rotate the rotatable element 20 according to the change of the inclined usage angle of the portable electronic device Z, thus the first horizontal line H1 concurrently passing through the first geometric center point C1 of the rotatable element 20 and the two second geometric center points C2 itself of the two image-capturing modules 21 is always horizontal to the level line by gravity.

Hence, no matter the portable electronic device Z is rotated to a vertical usage angle, a horizontal usage angle or an inclined usage angle, the gyroscope module 30 can keep the first horizontal line H1 horizontal, thus the two image-capturing modules 21 can be always symmetrically and horizontally disposed on opposite sides of the vertical line V. Therefore, no matter how the usage angle of the portable electronic device Z is changed, the usage angle of the two image-capturing modules 21 cannot be changed, thus the user can use the portable electronic device Z to capture high quality 3D images at any usage angle. Of course, the portable electronic device Z of the seventh embodiment can use the securing element 12 as shown in the first embodiment to the fifth embodiments to selectively secure or release the rotatable element 20.

In conclusion, because the two image-capturing modules 21 can be always held in a horizontal state, the portable electronic device Z can be used to capture high quality 3D images at any usage angle.

Furthermore, the three methods of “always keeping the two image-capturing modules 21 horizontal” as shown in the first, the sixth and the seventh embodiments are merely examples and are not meant to limit the instant disclosure. In other words, the instant disclosure can use many methods to always keep the two image-capturing modules 21 horizontal, for example, the weight element 22 can be disposed out of the rotatable element 20 or the rotatable element 20 has an eccentric shape etc. In addition, the four methods of “changing the usage angle of the two image-capturing modules 21 according to the change of the usage angle of the portable electronic device Z due to the rotatable element 20 secured by the securing element 12” as shown in the second to the fifth embodiments are merely examples and are not meant to limit the instant disclosure. In other words, the instant disclosure can use many methods to change the usage angle of the two image-capturing modules 21 according to the change of the usage angle of the portable electronic device Z due to the rotatable element 20 secured by the securing element 12, for example, the rotatable element 20 can be pressed through a pressing element etc.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A portable electronic device for capturing 3D images at any usage angle, comprising:
a carrier unit including a carrier body; and
an image-capturing unit including a rotatable element rotatably disposed on the carrier body, at least two image-capturing modules embedded in the rotatable element, and at least one weight element disposed inside the rotatable element, wherein the rotatable element has a first geometric center point that is concurrently passed by a first horizontal line and a vertical line, each image-capturing module has a second geometric center point itself that is passed by the first horizontal line, the at least one weight element has a third geometric center point that is passed by a second horizontal line and the vertical line, and the first horizontal line and the second horizontal line are horizontal to and separated from each other.

2. The portable electronic device of claim 1, wherein the carrier body has a front side and a back side, the carrier unit includes a display screen disposed on the front side of the carrier body, and the image-capturing unit is disposed on the back side of the carrier body.

3. The portable electronic device of claim 1, wherein the vertical line is vertical to the first horizontal line and the second horizontal line, and the at least two image-capturing modules are symmetrically disposed on opposite sides of the vertical line.

4. The portable electronic device of claim 1, wherein the carrier body has a receiving groove, and the rotatable element is rotatably disposed in the receiving groove of the carrier body, wherein the carrier body has a sliding groove communicated with the receiving groove, and the carrier unit includes a securing element slidably disposed in the sliding groove of the carrier body, wherein the securing element has a first retaining portion, the rotatable element has a second retaining portion corresponding to the first retaining portion, and the first retaining portion is positioned at one of a first position and a second position, wherein the first position is for securing the rotatable element by retaining the first retaining portion with the second retaining portion, and the second position is for releasing the rotatable element by separating the first retaining portion from the second retaining portion.

5. The portable electronic device of claim 1, wherein the carrier body has a receiving groove, and the rotatable element is rotatably disposed in the receiving groove of the carrier body, wherein the carrier body has a sliding groove communicated with the receiving groove, and the carrier unit includes a securing element slidably disposed in the sliding groove of the carrier body, wherein the securing element has a first magnetic portion, the rotatable element has a second magnetic portion corresponding to the first magnetic portion, and the first magnetic portion is positioned at one of a first position and a second position, wherein the first position is for securing the rotatable element by magnetically mating the first magnetic portion with the second magnetic portion, and the second position is for releasing the rotatable element by separating the first magnetic portion from the second magnetic portion.

6. The portable electronic device of claim 1, wherein the carrier body has a receiving groove, and the rotatable element is rotatably disposed in the receiving groove of the carrier body, wherein the carrier unit includes a securing element disposed in the receiving groove of the carrier body, and the rotatable element is liftably disposed in receiving groove, wherein the rotatable element is positioned at one of a first position and a second position, and the first position is for securing the rotatable element by tightly mating the rotatable element with the securing element, and the second position is for releasing the rotatable element by separating the rotatable element from the securing element.

7. The portable electronic device of claim 1, wherein the carrier body has a receiving groove, and the rotatable element is rotatably disposed in the receiving groove of the carrier body, wherein the carrier body has a positioning groove communicated with the receiving groove, and the carrier unit includes a securing element corresponding to the positioning groove of the carrier body, wherein the securing element has an end portion is positioned at one of a first position and a second position, the first position is for securing the rotatable element by retaining the end portion of the securing element in the positioning groove, and the second position is for releasing the rotatable element by separating the end portion of the securing element from the positioning groove.

8. A portable electronic device for capturing 3D images at any usage angle, comprising:
a carrier unit including a carrier body; and
an image-capturing unit including a rotatable element rotatably disposed on the carrier body and at least two image-capturing modules embedded in the rotatable element, wherein the rotatable element has a first geometric center point that is concurrently passed by a first horizontal line and a vertical line, each image-capturing module has a second geometric center point itself that is passed by a second horizontal line, and the first horizontal line and the second horizontal line are horizontal to and separated from each other.

9. The portable electronic device of claim 8, wherein the carrier body has a front side and a back side, the carrier unit includes a display screen disposed on the front side of the carrier body, and the image-capturing unit is disposed on the back side of the carrier body.

10. The portable electronic device of claim 8, wherein the carrier body has a receiving groove, and the rotatable element is rotatably disposed in the receiving groove of the carrier body, wherein the carrier body has a sliding groove communicated with the receiving groove, and the carrier unit includes a securing element slidably disposed in the sliding groove of the carrier body, wherein the securing element has a first retaining portion, the rotatable element has a second retaining portion corresponding to the first retaining portion, and the first retaining portion is positioned at one of a first position and a second position, wherein the first position is for securing the rotatable element by retaining the first retaining portion with the second retaining portion, and the second position is for releasing the rotatable element by separating the first retaining portion from the second retaining portion.

11. The portable electronic device of claim 8, wherein the carrier body has a receiving groove, and the rotatable element is rotatably disposed in the receiving groove of the carrier body, wherein the carrier body has a sliding groove communicated with the receiving groove, and the carrier unit includes a securing element slidably disposed in the sliding groove of the carrier body, wherein the securing element has a first magnetic portion, the rotatable element has a second magnetic portion corresponding to the first magnetic portion, and the first magnetic portion is positioned at one of a first position and a second position, wherein the first position is for securing the rotatable element by magnetically mating the first magnetic portion with the second magnetic portion, and the second position is for releasing the rotatable element by separating the first magnetic portion from the second magnetic portion.

12. The portable electronic device of claim 8, wherein the carrier body has a receiving groove, and the rotatable element is rotatably disposed in the receiving groove of the carrier body, wherein the carrier unit includes a securing element disposed in the receiving groove of the carrier body, and the rotatable element is liftably disposed in receiving groove, wherein the rotatable element is positioned at one of a first position and a second position, and the first position is for securing the rotatable element by tightly mating the rotatable element with the securing element, and the second position is for releasing the rotatable element by separating the rotatable element from the securing element.

13. The portable electronic device of claim 8, wherein the carrier body has a receiving groove, and the rotatable element is rotatably disposed in the receiving groove of the carrier body, wherein the carrier body has a positioning groove communicated with the receiving groove, and the carrier unit includes a securing element corresponding to the positioning groove of the carrier body, wherein the securing element has an end portion is positioned at one of a first position and a second position, the first position is for securing the rotatable element by retaining the end portion of the securing element in the positioning groove, and the second position is for releasing the rotatable element by separating the end portion of the securing element from the positioning groove.

14. A portable electronic device for capturing 3D images at any usage angle, comprising:
a carrier unit including a carrier body;
an image-capturing unit including a rotatable element rotatably disposed on the carrier body and at least two image-capturing modules embedded in the rotatable element, wherein the rotatable element has a first geometric center point that is concurrently passed by a first horizontal line and a vertical line, and each image-capturing module has a second geometric center point itself that is passed by the first horizontal line; and
a horizontal control unit including at least one gyroscope module electrically connected to the image-capturing unit for keeping the first horizontal line to pass through the second geometric center point itself of each image-capturing module, wherein the at least one gyroscope module is disposed inside one of the carrier body and the rotatable element.

15. The portable electronic device of claim 14, wherein the carrier body has a front side and a back side, the carrier unit includes a display screen disposed on the front side of the carrier body, and the image-capturing unit is disposed on the back side of the carrier body.

16. The portable electronic device of claim 14, wherein the vertical line is vertical to the first horizontal line, and the at least two image-capturing modules are symmetrically disposed on opposite sides of the vertical line.

17. The portable electronic device of claim 14, wherein the carrier body has a receiving groove, and the rotatable element is rotatably disposed in the receiving groove of the carrier body, wherein the carrier body has a sliding groove communicated with the receiving groove, and the carrier unit includes a securing element slidably disposed in the sliding groove of the carrier body, wherein the securing element has a first retaining portion, the rotatable element has a second retaining portion corresponding to the first retaining portion, and the first retaining portion is positioned at one of a first position and a second position, wherein the first position is for securing the rotatable element by retaining the first retaining portion with the second retaining portion, and the second position is for releasing the rotatable element by separating the first retaining portion from the second retaining portion.

18. The portable electronic device of claim 14, wherein the carrier body has a receiving groove, and the rotatable element is rotatably disposed in the receiving groove of the carrier body, wherein the carrier body has a sliding groove communicated with the receiving groove, and the carrier unit includes a securing element slidably disposed in the sliding groove of the carrier body, wherein the securing element has a first magnetic portion, the rotatable element has a second magnetic portion corresponding to the first magnetic portion, and the first magnetic portion is positioned at one of a first position and a second position, wherein the first position is for securing the rotatable element by magnetically mating the first magnetic portion with the second magnetic portion, and the second position is for releasing the rotatable element by separating the first magnetic portion from the second magnetic portion.

19. The portable electronic device of claim 14, wherein the carrier body has a receiving groove, and the rotatable element is rotatably disposed in the receiving groove of the carrier body, wherein the carrier unit includes a securing element disposed in the receiving groove of the carrier body, and the rotatable element is liftably disposed in receiving groove, wherein the rotatable element is positioned at one of a first position and a second position, and the first position is for securing the rotatable element by tightly mating the rotatable element with the securing element, and the second position is for releasing the rotatable element by separating the rotatable element from the securing element.

20. The portable electronic device of claim 14, wherein the carrier body has a receiving groove, and the rotatable element is rotatably disposed in the receiving groove of the carrier body, wherein the carrier body has a positioning groove communicated with the receiving groove, and the carrier unit includes a securing element corresponding to the positioning groove of the carrier body, wherein the securing element has an end portion is positioned at one of a first position and a second position, the first position is for securing the rotatable element by retaining the end portion of the securing element in the positioning groove, and the second position is for releasing the rotatable element by separating the end portion of the securing element from the positioning groove.
